(19) United States
(12) Patent Application Publication
(10) Pub. No.: US 2022/0417435 A1
(43) Pub. Date: Dec. 29, 2022

(54) IMAGE PROCESSING DEVICE AND OPERATION METHOD THEREOF

(71) Applicant: RESEARCH & BUSINESS FOUNDATION SUNGKYUNKWAN UNIVERSITY, Suwon-si (KR)

(72) Inventors: Byeungwoo JEON, Seongnam-si (KR); Jaelin LEE, Suwon-si (KR)

(73) Assignee: RESEARCH & BUSINESS FOUNDATION SUNGKYUNKWAN UNIVERSITY, Suwon-si (KR)

(21) Appl. No.: 17/849,147

(22) Filed: Jun. 24, 2022

(30) Foreign Application Priority Data
Jun. 24, 2021 (KR) 10-2021-0082197

(51) Int. Cl. H04N 5/232; H04N 5/235; G06T 5/00; G06T 5/50; G06T 7/246

(52) U.S. Cl. CPC H04N 5/23267; H04N 5/23254; H04N 5/2353; G06T 5/003; G06T 5/50; G06T 7/248; G06T 2207/30241

(57) ABSTRACT

There is provided an image processing device including: a camera outputting a first image obtained by photographing an object that is moving; and a control module generating a coded pattern for controlling a shutter exposure time and reconstructing a second image in which motion blur of the first image is removed, wherein the control module detects a moving speed of the object, and generates the coded pattern based on a point spread function (PSF) range set according to the moving speed.

### CROSS-REFERENCE TO RELATED APPLICATION(S)

This application claims benefit of priority to Korean Patent Application No. 10-2021-0082197 filed on Jun. 24, 2021 in the Korean Intellectual Property Office, the disclosure of which is incorporated herein by reference in its entirety.

### BACKGROUND

1. FIELD

The present disclosure relates to an image processing device and an operation method thereof, and more particularly, to an image processing device that generates a coded pattern in which a speed and a trajectory of an object that is moving are reflected and removes motion blur of a captured image to reconstruct a clear image, and an operation method thereof.

2. DESCRIPTION OF RELATED ART

Traditionally, a clear image with reduced motion blur has obtained by estimating a point spread function (PSF) of motion blur occurring in an image obtained by a camera and performing deconvolution of the PSF in the obtained image.

However, a shutter pattern of the camera serves as a band-pass filter, and thus, adversely affects invertibility at the time of performing the deconvolution of the PSF.

Taking this into consideration, a technology called a coded exposure photography (CEP) technology that modulates the PSF so that invertibility is good by modulating the shutter pattern of the camera or a pattern of a light to be obtained has been developed. This is a technology that modulates the PSF so that the invertibility is good according to a coded pattern generated by the CEP technology.

The CEP technology studied up to recently is a method of optimizing a coded pattern for a PSF temporarily determined at a specific target length/shape.

However, in an actual environment, prior information on motion blur of an obtained image is not known, and thus, a mismatch problem occurs between the PSF modeled in order to generate the optimized coded pattern and an actual PSF in the obtained image.

Such a mismatch problem causes a problem that invertibility of the coded pattern generated by the traditional CEP technology does not show optimal performance.

### SUMMARY

An aspect of the present disclosure provides an image processing device that generates a coded pattern in which a speed and a trajectory of an object that is moving are reflected and removes motion blur of a captured image to reconstruct a clear image, and an operation method thereof.

An aspect of the present disclosure also provides an image processing device that designs various types of temporary point spread functions (PSFs) in advance and generates coded patterns exhibiting optimal performance for all the designed point spread functions, and an operation method thereof.

Aspects of the present disclosure are not limited to the above-described aspects, and other aspects and advantages of the present disclosure that are not mentioned may be understood by the following description and will be more clearly understood by embodiments of the present disclosure. In addition, it may be easily appreciated that aspects and advantages of the present disclosure may be realized by means mentioned in the claims and a combination thereof.

According to an aspect of the present disclosure, an image processing device may include: a camera outputting a first image obtained by photographing an object that is moving; and a control module generating a coded pattern for controlling a shutter exposure time and reconstructing a second image in which motion blur of the first image is removed, wherein the control module detects a moving speed of the object, and generates the coded pattern based on a point spread function (PSF) range set according to the moving speed.

The control module may determine the point spread function range based on a moving trajectory of the object in previous images obtained by photographing the object.

The control module may generate the coded pattern based on a mean cost of the point spread function range.

The control module may generate the coded pattern by applying a weight for an occurrence probability of the motion blur.

When the first image is input, the control module may reconstruct the second image in which the motion blur is removed from the first image according to a point spread function modulated by the coded pattern.

According to another aspect of the present disclosure, an operation method of an image processing device may include: detecting a moving speed of an object that is moving;

generating a coded pattern based on a point spread function (PSF) range set according to the moving speed; controlling a shutter exposure time based on the coded pattern to operate a camera so as to photograph the object; and reconstructing a second image in which motion blur of a first image captured by the camera is removed.

In the generating of the coded pattern, the point spread function range may be determined based on a moving trajectory of the object in previous images obtained by photographing the object.

In the generating of the coded pattern, the coded pattern may be generated based on a mean cost of the point spread function range.

In the generating of the coded pattern, the coded pattern may be generated by applying a weight for an occurrence probability of the motion blur.

In the reconstructing of the second image, the second image in which the motion blur is removed from the first image may be reconstructed according to a point spread function modulated by the coded pattern.

### BRIEF DESCRIPTION OF DRAWINGS

FIG. 1 is a control block diagram illustrating control components of an image processing device according to the present disclosure;

FIG. 2 is a flowchart illustrating an operation method of the image processing device according to the present disclosure; and

FIGS. 3A to 3E are views illustrating an experimental example of reconstruction in the image processing device according to the present disclosure.

### DETAILED DESCRIPTION

The present disclosure may be variously modified and have several embodiments, and thus, specific embodiments will be illustrated in the accompanying drawings and be described in detail. However, it is to be understood that the present disclosure is not limited to a specific embodiment, but includes all modifications, equivalents, and substitutions without departing from the spirit and scope of the present disclosure. Throughout the drawings, similar components will be denoted by similar reference numerals.

The terms such as ‘first’, ‘second’, ‘A’, and ‘B’ may be used to describe various components, but these components are not to be limited by these terms. These terms are used only to distinguish one component from another component. For example, a ‘first’ component may be named a ‘second’ component and the ‘second’ component may also be similarly named the ‘first’ component, without departing from the scope of the present disclosure. The term ‘and/or’ includes a combination of a plurality of related described items or any one of the plurality of related described items.

It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

The terms used herein are used only in order to describe specific embodiments rather than limiting the present disclosure. Singular forms are intended to include plural forms unless the context clearly indicates otherwise. It is to be understood that the terms “include” or “has” used herein specify the presence of features, numerals, steps, operations, components, parts mentioned in the present specification, or combinations thereof, and do not preclude the presence or addition of one or more other features, numerals, steps, operations, components, parts, or combinations thereof.

Unless defined otherwise, it is to be understood that all the terms used herein including technical and scientific terms have the same meanings as those generally understood by those skilled in the art to which the present disclosure pertains. The terms as defined by a generally used dictionary are to be interpreted to be identical with the meanings within the context of the related art, and they are not interpreted as ideally or excessively formal meanings unless explicitly defined herein.

Hereinafter, exemplary embodiments of the present disclosure will be described in detail with reference to the accompanying drawings.

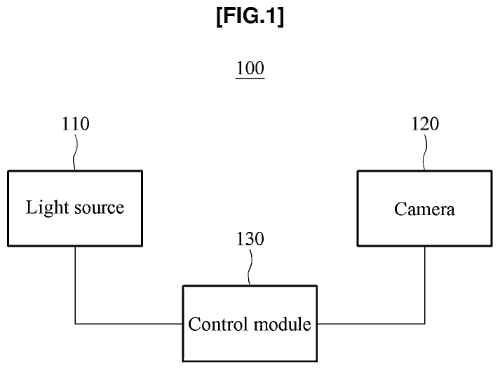

FIG. 1 is a control block diagram illustrating control components of an image processing device according to the present disclosure.

Referring to FIG. 1, the image processing device 100 may include a light source 110, a camera 120, and a control module 130.

The light source 110 may emit at least one light.

That is, the light source 110 may be turned on/off by the control module 130 to emit a light having at least one color, but is not limited thereto.

The camera 120 may output a first image obtained by photographing a moving object by exposing a shutter according to a shutter exposure pattern (time).

The camera 120 may be any one of a light field (LF) camera, a multi-view camera, and a stereo camera capable of capturing several images at the same time, but is not limited thereto.

The control module 130 may generate the shutter exposure pattern corresponding to a coded pattern.

Here, although the shutter exposure pattern is described as changing the shutter exposure time of the camera 120, a turn-on/off operation of the light source 110 may be controlled, but the present disclosure is not limited thereto.

The control module 130 may receive the first image obtained by photographing the moving object by adjusting the shutter exposure time of the camera 120 according to the shutter exposure pattern.

In this case, the control module 130 may reconstruct a second image by removing motion blur of the first image according to a point spread function modulated by the coded pattern.

The control module 130 may detect a moving speed of an object in order to ensure invertibility of the coded pattern, and generate the coded pattern based on a point spread function (PSF) range set according to the moving speed.

In addition, the control module 130 may generate the coded pattern based on a PSF range set for motion blur of previously captured images.

Here, the PFS range may be determined as a trajectory along which the object in the previous images moves.

The control module 130 may generate the coded pattern based on a mean cost value of PSFs falling within the PSF range.

That is, the control module 130 may generate the coded pattern by applying a weight for an occurrence probability of the motion blur to a cost of each PSF within the PSF range.

The control module 130 may generate a coded pattern optimized for the PSF of the motion blur.

Here, the control module 130 may assume a PSF shape of the motion blur that may occur in the previously captured images, and then generate a coded pattern with the best reconstruction performance on average in an assumed range of the motion blur.

First, the control module 130 may calculate a cost function in order to generate the coded pattern.

Here, the cost function may be determined by a variance and a minimum value of the coded pattern, and is defined as represented by Equation 1.

$${m}_{1}^{K} = \frac{1}{min ( MTF ( {h}_{K} ) )} , {m}_{2}^{K} = var ( MTF ( {h}_{K} ) ) \qquad [ Equation 1 ]$$

$$C ( U ) = {\sum }_{a = 1}^{2} {ω}_{a} {m}_{a}$$

Here, ω_{α} is a weight according to an effective degree of a cost of an obtained image, m_{α} is a cost indicating invertibility of a PSF modulated by a coded pattern, and is determined, for example, according to a type of motion defined as h, and this value may be experimentally calculated.

C_{K}(U) may indicate a cost function calculated based on the modulated PSF that changes according to the motion blur K.

In addition, m₁^{K},m₂^{K} may indicate invertibility of the modulated PSF.

Here, the cost function for finally generating the coded pattern may be defined as represented by Equation 2.

$$Q ( U ) = {\sum }_{K ∈ Ω} {p}_{K} {C}_{K} ( U ) \qquad [ Equation 2 ]$$

Q(U) indicates an optimized pattern as it becomes closer to 0, P_{K} is a probabilistic model, and h_{K} may refer to a probability that the motion blur will actually occur.

In a case where the probabilistic model may be inferred, for example, in a case of a surveillance camera with a speed limit of 100 km/h, the probabilistic model for motion may be calculated for a predetermined period. In this case, when the probabilistic model is weighted on the calculated cost function, a coded pattern with good invertibility may be generated for the PSF that more frequently occurs.

That is, through Equation 2, the control module 130 may generate a coded pattern with optimized performance by applying the mean cost value to the PSFs of the motion blur within the set PSF range.

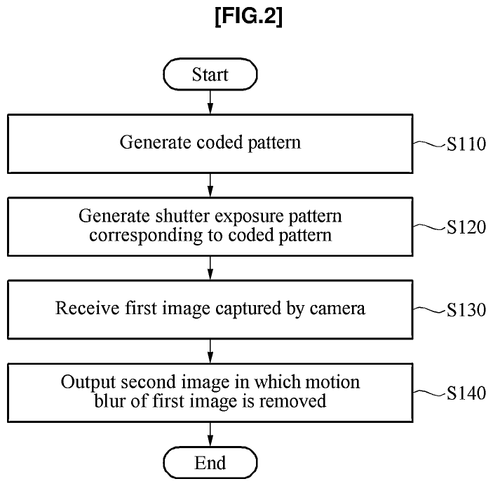

FIG. 2 is a flowchart illustrating an operation method of the image processing device according to the present disclosure.

Referring to FIG. 2, the image processing device 100 may generate the coded pattern (S110), and operate the camera 120 so as to photograph an object moving at a constant speed according to a shutter exposure pattern corresponding to the coded pattern.

Thereafter, the control module 130 may reconstruct the second image in which the motion blur of the first image captured by the camera is removed according to the coded pattern.

In more detail, the control module 130 may generate the shutter exposure pattern corresponding to the coded pattern (s120).

Here, although the shutter exposure pattern is described as changing the shutter exposure time of the camera 120, a turn-on/off operation of the light source 110 may be controlled, but the present disclosure is not limited thereto.

The control module 130 may receive the first image obtained by photographing the moving object by adjusting the shutter exposure time of the camera 120 according to the shutter exposure pattern (S130).

In this case, the control module 130 may reconstruct the second image by removing the motion blur of the first image according to the coded pattern (S140).

The control module 130 may detect a moving speed of an object, and generate the coded pattern based on a PSF range set according to the moving speed.

The control module 130 may generate the coded pattern based on PSFs for motion blur of previously captured images in order to ensure invertibility of the coded pattern.

Here, the PFS range may be determined as a trajectory along which the object in the previous images moves.

The control module 130 may generate the coded pattern based on a mean cost value of PSFs falling within the PSF range.

That is, the control module 130 may generate the coded pattern by applying a weight for an occurrence probability of the motion blur to a cost of each PSF within the PSF range.

The control module 130 may generate a coded pattern optimized for the PSF of the motion blur.

Here, the control module 130 may assume a PSF shape of the motion blur that may occur in the previously captured images, and then generate a coded pattern with the best reconstruction performance on average in an assumed range of the motion blur.

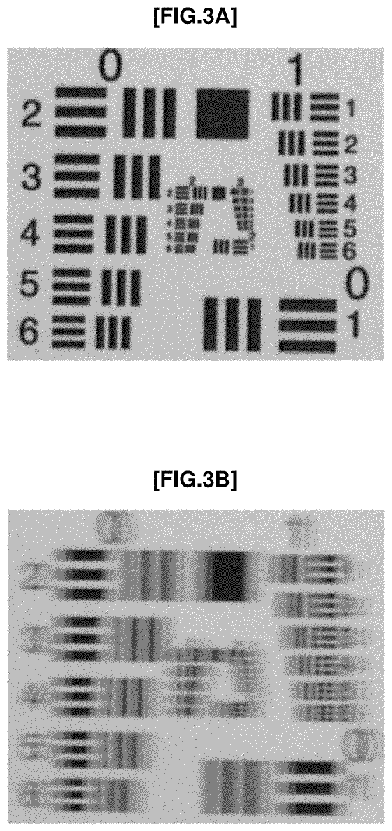

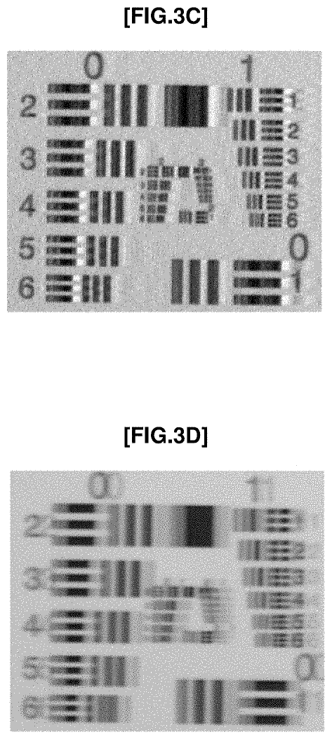

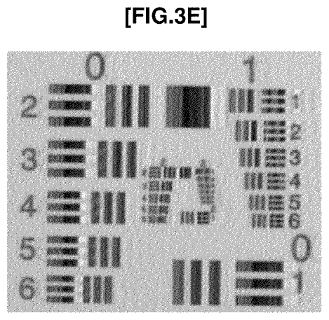

FIGS. 3A to 3E are views illustrating an experimental example of reconstruction in the image processing device according to the present disclosure.

FIG. 3A is an original image, FIGS. 3B and 3D are images reconstructed with a traditional coded pattern, and FIGS. 3C and 3E are images reconstructed with an optimized coded pattern.

First, an object is set to move at an arbitrary speed, and a range of the speed is limited to approximately 1 to 28 pixels/camera exposure time.

When a moving speed of the object is unknown, images modulated with coded patterns of FIGS. 3B and 3D are obtained using an optimized coded pattern composed of one element. FIGS. 3C and 3E may be reconstruction results of FIGS. 3B and 3D, respectively.

As illustrated in results of FIGS. 3C to 3E, it may be visually confirmed that an image of FIG. 3E is an image of which a ringing artifact and a color artifact are decreased and an image quality is better than a reconstructed image of FIG. 3C.

A traditional method is optimized for a pattern composed of one element. The reason is that when the motion blur of the PSF is actually 20 pixels/exposure time, the coded pattern having a length of 14 should be interpolated to be appropriate for 20, and thus, reconstruction performance is not guaranteed.

On the other hand, the image processing device shows good cost function results on average between 1 and 28, and thus, shows probabilistically excellent reconstruction performance.

Table 1 is a cost table of a pattern composed of one element, and proves significance between experimental results and the cost function according to the present disclosure.

FIGS. 3A to 3E are cases where lengths of a vector of a PSF in a cost function table are 18 and 20, respectively. According to Table 1, it can be seen that when the lengths of the vector of the PSF are 18 and 20, a cost of the present disclosure is lower, and thus, better recognition performance is obtained.

TABLE 1

| | U(n) | | |
|---|---|---|---|
| | Non-coded | Traditional | Proposed |
| K | 11111111111111 | 11011000110001 | 11110010000101 |
| 14 (K = N | −6.9825 | −4.5165 | −4.5771 |
| case) | | | |
| 15 | −7.0170 | −4.7974 | −4.9893 |
| 16 | −7.0492 | −5.1233 | −4.7656 |
| 17 | −7.0795 | −5.1160 | −4.8587 |
| 18 | −7.1080 | −5.0098 | −4.8928 |
| 19 | −7.1349 | −5.1038 | −5.1095 |
| 20 | −7.1604 | −5.1495 | −4.7973 |
| 21 | −7.1848 | −5.4997 | −5.1562 |
| 22 | −7.2081 | −5.2093 | −5.0651 |
| 23 | −7.2302 | −5.8683 | −5.4258 |
| 24 | −7.2514 | −5.4387 | −5.4427 |
| 25 | −7.2715 | −5.3981 | −5.1910 |
| 26 | −7.2912 | −5.7105 | −5.5398 |
| 27 | −7.3101 | −5.8920 | −5.2616 |
| 28 (K = 2N | −7.3281 | −6.1805 | −5.7198 |
| case) | | | |
| Mean score | −7.1738 | −5.3342 | −5.1195 |

The image processing device and the operation method thereof according to the present disclosure may reconstruct a clear image by removing motion blur of an image obtained during an exposure time of a camera through a coded pattern generated based on a point spread function range set according to at least one of a moving speed and a moving trajectory of an object in a case of a single-view general camera and a multi-view camera, for example, a light field camera and a stereo camera.

Meanwhile, effects of the present disclosure are not limited to the above-mentioned effects, and various effects may be included within the range apparent to those skilled in the art from a description to be described later.

Features, structures, effects, and the like, described in embodiments hereinabove are included in at least one embodiment of the present disclosure, and are not necessarily limited to only one embodiment. Furthermore, features, structures, effects, and the like, exemplified in each embodiment may be combined with each other or modified for other embodiments by those skilled in the art to which embodiments belong. Accordingly, contents related to such combinations and modifications are to be interpreted as falling within the scope of the present disclosure.

In addition, although an embodiment has been mainly described hereinabove, this is mere an example and does not limit the present disclosure, and those skilled in the art to which the present disclosure pertains may understand that several modifications and applications that are not described hereinabove may be made without departing from the spirit and scope of the present disclosure. For example, the respective components specifically described in an embodiment of the present disclosure may be modified. In addition, differences associated with these modifications and applications are to be interpreted as falling within the scope of the present invention as defined by the following claims.

What is claimed is:

1. An image processing device comprising:
a camera outputting a first image obtained by photographing an object that is moving; and
a control module generating a coded pattern for controlling a shutter exposure time and reconstructing a second image in which motion blur of the first image is removed,
wherein the control module detects a moving speed of the object, and generates the coded pattern based on a point spread function (PSF) range set according to the moving speed.

2. The image processing device of claim 1, wherein the control module determines the point spread function range based on a moving trajectory of the object in previous images obtained by photographing the object.

3. The image processing device of claim 1, wherein the control module generates the coded pattern based on a mean cost of the point spread function range.

4. The image processing device of claim 1, wherein the control module generates the coded pattern by applying a weight for an occurrence probability of the motion blur.

5. The image processing device of claim 1, wherein when the first image is input, the control module reconstructs the second image in which the motion blur is removed from the first image according to a point spread function modulated by the coded pattern.

6. An operation method of an image processing device, comprising:
detecting a moving speed of an object that is moving;
generating a coded pattern based on a point spread function (PSF) range set according to the moving speed;
controlling a shutter exposure time based on the coded pattern to operate a camera so as to photograph the object; and
reconstructing a second image in which motion blur of a first image captured by the camera is removed.

7. The operation method of an image processing device of claim 6, wherein in the generating of the coded pattern, the point spread function range is determined based on a moving trajectory of the object in previous images obtained by photographing the object.

8. The operation method of an image processing device of claim 6, wherein in the generating of the coded pattern, the coded pattern is generated based on a mean cost of the point spread function range.

9. The operation method of an image processing device of claim 6, wherein in the generating of the coded pattern, the coded pattern is generated by applying a weight for an occurrence probability of the motion blur.

10. The operation method of an image processing device of claim 6, wherein in the reconstructing of the second image, the second image in which the motion blur is removed from the first image is reconstructed according to a point spread function modulated by the coded pattern.
